(19) United States
(12) Patent Application Publication
(10) Pub. No.: US 2018/0213122 A1
(43) Pub. Date: Jul. 26, 2018

(54) SECURELY SENDING A DIGITAL IMAGE OF A DOCUMENT TO AN INTENDED RECIPIENT VIA FAX

(71) Applicant: Xerox Corporation, Norwalk, CT (US)

(72) Inventors: Surya Prakash KOTHA, Chennai (IN); Ramesh NAGARAJAN, Pittsford, NY (US)

(21) Appl. No.: 15/416,812

(22) Filed: Jan. 26, 2017

(51) Int. Cl. H04N 1/44; H04N 1/00; H04N 1/32

(52) U.S. Cl. CPC H04N 1/444; H04N 1/00209; H04N 1/00241; H04N 1/4413; H04N 2201/3226; H04N 1/32122; H04N 2201/0093; H04N 2201/0039; H04N 1/4426

(57) ABSTRACT

What is disclosed is a system and method for securely sending a digital document to an intended recipient via facsimile transmission. A fax device is used to obtain a digital document to be faxed. A sender of the fax enters an access code into the fax device which is associated with the digital document. The digital document is transmitted by the fax device to a second fax device. The access code is communicated to an intended recipient who enters the access code into the second fax device. The second fax device retrieves the digital document associated with this access code and communicates the digital document to a print engine which renders the digital document to a hardcopy print.

### TECHNICAL FIELD

The present invention is directed to systems and methods for securely sending a digital image of a hardcopy document to an intended recipient via facsimile (fax) transmission.

### BACKGROUND

It is not uncommon for people to forget to retrieve faxed document page(s) from the output tray of the receiving fax device. As such, a document containing personal information or other sensitive subject matter simply resides in the receiving fax device's output tray until the intended recipient comes by to retrieve the faxed document. This leaves the faxed document viewable by someone other than the recipient. Moreover, a document intended for one recipient may be inadvertently retrieved from the receiving fax device's output tray by someone other than the intended recipient. Methods are increasingly needed to help ensure that a faxed document is only received by the intended recipient. The present invention is specifically directed to this ongoing effort.

### BRIEF SUMMARY

What is disclosed is a system and method for securely sending a digital image of a hardcopy document to an intended recipient via facsimile (fax) transmission. In accordance with one embodiment hereof, a first person (sender) uses a first fax device to obtain a digital image of a document to be communicated via facsimile transmission to a second person (recipient). The sender enters an access code into the first fax device. A first processor of the first fax device executes a first set of machine readable program instructions which configure the first processor to receive the access code entered by the sender and associate that access code with the stored digital image. The association is such that the digital image cannot be retrieved from the storage device without the access code. The digital image is communicated to a second fax device. The access code is communicated to the recipient. Upon receiving the access code, the recipient enters the access code into the second fax device. A second processor of the second fax device executes a second set of machine readable program instructions which configure the second processor to receive the transmitted digital image from the first fax device, receive the access code from the recipient, and communicate the digital image associated with the access code to a print engine which renders the digital document to a hardcopy print.

Features and advantages of the above-described method will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 is a flow diagram which illustrates one example embodiment of the present method for securely sending a digital image of a hardcopy document to an intended recipient via fax transmission; and

FIG. 2 illustrates one embodiment of a networked computing environment wherein one or more aspects of the present method likely find their intended uses.

### DETAILED DESCRIPTION

What is disclosed is a system and method for securely sending a digital image of a hardcopy document to an intended recipient via fax. It should be understood that one of ordinary skill in this art would be readily familiar with fax machines, sending/receiving a faxed document, entering information into a fax device's display, and other facets related to operating a fax device and performing facsimile transmission.

### Non-Limiting Definitions

The term “fax” (from the Latin “fac-simile” meaning “to make similar”) is a technology used to send/receive electronic copies of documents between devices placed in electronic communication with each other over a network. Facsimile transmission has an advantage over postal carrier or courier in that the delivery of the document is nearly instantaneous. Although devices for electronically transmitting documents electrically have existed in various forms since the mid-20^{th} century, modern fax machines became relatively widely available in the 1970s as electronic sophistication increased with expanding infrastructure. Over time, fax machines became quite affordable and by the late-1980s were widely used in commerce. In more recent times, this technology has been relegated to a position beneath email as a prevailing form of document transmission. Although fax machines has faced increasing competition from Internet-based systems, facsimile transmission still retain advantages. For example, in many countries, electronic signatures on faxed documents are recognized as legally binding.

A “sender” is the person sending a digital image of a hardcopy document using a fax device.

A “recipient” or “intended recipient” is the person receiving a faxed document using a fax device.

A “fax device” or “fax machine”, as are generally known, typically consist of an image scanner, a communications interface, and a user interface such as a touchscreen display for effectuating a user interaction through selectable menu options displayed thereon. Many fax devices provide additional means for receiving a user input such as, for example, a keyboard, keypad, mouse, and the like. It should also be understood that one or more functions, features, and capabilities of one or more aspects of the present method may be performed by processor or special purpose ASIC integrated, in whole or in part, with a system or sub-system of a fax device. An image scanner of a fax device optically scans a document and converts it to a digital document. Some image scanners use a charge-coupled device (CCD) scanners which contain rows of sensors with filters such as (red, green, blue). Other image scanners use a contact image sensor (CIS) which consists of a moving set of strobed red, green, and blue LEDs and a monochromatic photodiode array for light collection. The scanning bed is usually composed of a glass pane (platen) under which the light illuminates the pane while a moving optical array performs scanning.

In operation, a sender places a document to be electronically scanned onto the platen, closes the lid, enters a number of a destination fax device into the device's user interface and then typically presses a “SCAN” or “SEND” button. The sensors and light sources move across the pane beneath the platen. The light is reflected off the face of the document on the platen and the reflection detected by the sensors forms a digital image of the document. By scanning a document in such a manner, the image scanner obtains a digital document, often called the “facsimile”. The digital image is stored to a storage device such as memory. Thereafter, the fax device proceeds to establish an electronic communication with the recipient's device by, for example, dialing a telephone number of the destination fax device. Once communication between the sending fax device and the receiving fax device has been established, the digital image is retrieved from memory and electronically transmitted. Upon completion of the transmission, the sending device typically will print a confirmation page which then sits in an output tray of the sender's fax machine until retrieved.

A “digital image”, also referred to herein as a “digital document” means a digitized representation of a hardcopy print. A digital image is transmitted in the form of electronic signals over a communication pathway established between a first and second fax device. The step of communicating the digital image is also intended to include storing digitized document to a memory or storage device.

An “access code” broadly refers to a security code which is provided by a first person (sender) to a first fax device and which is associated with the digital image of the document intended to be faxed. The association is such that the digital document cannot be retrieved from the storage device without the access code. Example access codes include a sequence of numbers, a sequence of letters, and an alphanumeric sequence. In other embodiments, the access code is an image entered or otherwise communicated by the user to the fax device using, for example, an optical reader/scanner placed in communication with the fax device. The access code may be a barcode pattern communicated to the fax device using a barcode reader/scanner placed in communication with the fax device. In these embodiments, the sender and recipient would both have access to the same image or barcode pattern which may reside on, for example, their employee badge or an ID card. In another embodiment, the access code is communicated to the fax device by an RFID tag which is read by a RF-sensor placed in communication with the fax device. As are known in the arts, RFID tags utilize radio frequency (RF) signals. In this embodiment, the sender and recipient would both have a similarly configured RFID tags. In another embodiment, the access code is communicated to the fax device by, for example, inserting a USB drive or other memory/storage device containing the access code into a port of the fax device which is retrieved from the inserted drive. In this embodiment, the sender would provide the USB drive to the recipient. A smartphone can be used to communicate the access code to the fax device. The sender would text/email the access code to the recipient so they can provide it to their fax device to retrieve the transmitted digital document.

“Receiving an access code” is intended to be widely construed and includes: retrieving, acquiring, or otherwise obtaining the access code used by the sender. An access code can be retrieved from a storage device such as a CDROM or DVD, or from a remote device such as a handheld computing device or smartphone over a wired or wireless network.

A “storage device” refers to a drive, device, or system which electronically stores digital documents. Storage devices include Memory, flash drives, USB devices, hard drives, and other volatile or non-volatile storage media.

It should be appreciated that the steps of “receiving”, “retrieving”, “using”, “communicating”, “performing”, “providing”, “selecting”, “associating”, “deleting”, and the like, as used herein, include the application of any of a variety of techniques as well as mathematical operations according to any specific context or for any specific purpose. It should be appreciated that such steps may be facilitated or otherwise effectuated by a microprocessor executing machine readable program instructions such that the intended functionality is effectively performed.

### Flow Diagram of One Example Embodiment

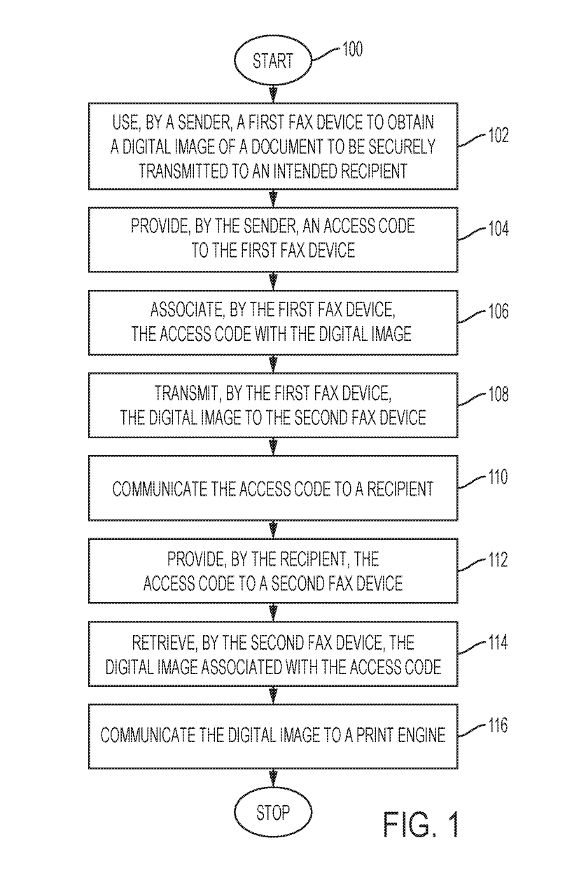

Reference is now being made to the flow diagram of FIG. 1 which illustrates one example embodiment of the present method for securely sending a digital image of a hardcopy document to an intended recipient via fax. Flow processing begins at step 100 and immediately proceeds to step 102.

At step 102, use, by a sender, a first fax device to obtain a digital image of a document to be securely transmitted to an intended recipient.

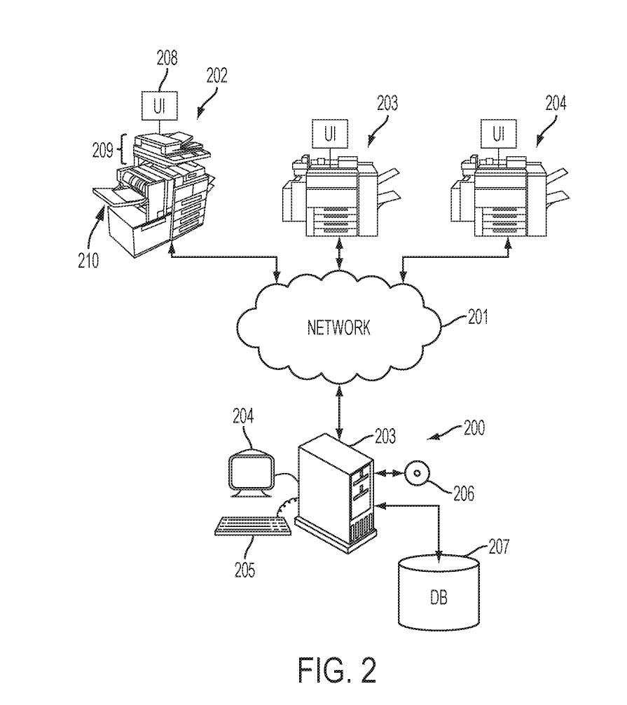

At step 104, provide, by the sender, an access code to the first fax device. The sender may utilize, for example, the UI 208 of FIG. 2 to communicate the access code to the first fax device.

At step 106, associate, by the first fax device, the access code with the digital image. A processor (internal to the first fax device) executes machine readable program instruction which enable the processor to associate the sender's access code with the digital image. In one embodiment, the access code is used, in whole or in part, as the name of the digital document saved to a storage device. In such a manner, the digital document will not be retrieved without knowing the access code.

At step 108, transmit, by the first fax device, the digital image to a second fax device.

At step 110, communicate the access code to the recipient. In one embodiment, the first fax machine communicates the access code via text message, email, image, or audio message directly to the recipient, for example, to the recipient's smartphone or computer system.

At step 112, provide, by the recipient, the access code to a second fax device. The recipient may utilize, for example, the UI 208 of FIG. 2 to communicate the access code to the second fax device.

At step 114, retrieve, by the second fax device, the digital image associated with the access code. A processor (internal to the second fax device) executes machine readable program instruction which facilitate the retrieval of the digital document associated with the access code provided by the recipient. The digital document may be retrieved from a storage device local to the second fax device or, alternatively, from a cloud-based storage device which has received the digital document from the first fax device.

At step 116, communicate the digital image to a print engine. The print engine may be local to the second fax machine or may be a separate printer in wired or wireless communication with the second fax device. In this embodiment, further processing stops. In another embodiment, the digital document is deleted from the storage device.

It should be appreciated that the flow diagrams hereof are illustrative. One or more of the operative steps illustrated in any of the flow diagrams may be performed in a differing order. Other operations, for example, may be added, modified, enhanced, condensed, integrated, or consolidated with the steps thereof. Such variations are intended to fall within the scope of the appended claims. All or portions of the flow diagrams may be implemented partially or fully in hardware in conjunction with machine executable instructions.

### Example Networked Environment

Reference is now being made to FIG. 2 which illustrates one embodiment of a networked computing environment wherein one or more aspects of the present method are likely to find their intended uses.

Document reproduction devices 202, 203, 204 are shown incorporating a user interface (UI) 208 for enabling the user thereof to enter an access code. In one embodiment, the UI displays user-selectable menu options and other information. The UI may be a touchscreen device for receiving a user input via a touch-sensitive surface. The UI may further include a keyboard, keypad, mouse, and the like. In other embodiments, the UI comprises or further comprises a RFID sensor, an optical reader, a barcode reader, a port for a physically connecting an external device thereto, or a wired or wireless interface placed in communication with remote devices over a network such as a smartphone. The UI may enable a user to program a processor to carry out various embodiments hereof or to configure any of the networked devices to perform various aspects of the teachings hereof. The fax devices further include functionality to scan a document (generally at 209) and a print engine (not shown) which renders a digital document to a hardcopy print that is deposited in output tray 210. Each of the fax devices are similarly configured and are each capable of performing a scan/fax/print function. It should be appreciated that some or all of the fax devices of FIG. 2 further incorporate various features, capabilities, and functionality for transmitting a digital document over network 201 to any of the other devices and for receiving a digital document from any of the networked devices. Techniques for placing a computer in networked communication with one or more fax devices are well established. Therefore, a discussion of techniques for placing such systems and devices in networked communication has been omitted. The fax devices of FIG. 2 are shown in communication with a computer system.

Computer system 200 is shown comprising a computer case 203 housing therein a motherboard, CPU, memory, storage device, and a communications link such as a network card. The computer system also includes a display 204 such as a CRT or LCD. An alphanumeric keyboard 205 and a mouse (not shown) enable a user input or selection. Computer readable medium 206 contains machine executable instructions and other program instructions for implementing the functionality and features hereof. Such a computer platform includes storage device 207 for storage and retrieval of digital documents. One or more of the fax devices may be placed in communication with storage device 207 to retrieve digital documents therefrom. Computer 200 may further enable a user to configure any of the networked fax devices to perform the present methods or to enable a user to use the computer system to perform the methods disclosed herein. Computer 200 may be configured to run a server software program (or house server hardware) for hosting installed applications which can be distributed on-demand to the networked fax devices. Computer 200 may be configured to create and run service proxies for directing requests for applications from a client device to the platform hosting the requested application and for redirecting responses from a host device to a requesting client device. The computer system of FIG. 2 may be a desktop, laptop, server, mainframe, or the like, and includes at least one processor executing machine readable program instructions.

The computer 200 and the fax devices 102, 103, 104 each include a network card (not shown) which facilitates the transmission of signals comprising a digital document over a network 201. Typical network interface cards include Local Area Network (LAN) and Wireless Area Network (WAN) functionality. The fax devices of FIG. 2 also include one or more processors executing program instructions for implementing one or more aspects of the present method.

Any of the fax devices of FIG. 2 may further incorporate a special purpose circuit which includes a processor and a bus, main memory which may comprise a buffer which stores machine readable program instructions addressable by the processor for carrying out the present method. Such a special purpose circuit may further incorporate a storage device which may be removable. A special purpose circuit may further include a communications interface which acts as both an input and an output to allow a digital document to be transferred between the system and external devices. Example interfaces include a modem, a network card, a communications port, etc. Software and data are transferred in the form of signals which may be electronic, electromagnetic, optical, or other forms of signals. Such signals may be transmitted using wire, cable, fiber optic, phone line, cellular link, RF, memory, or other means known in the arts.

The teachings hereof can be implemented in hardware or software using any known or later developed systems, structures, devices, and/or software by those skilled in the applicable art without undue experimentation from the functional description provided herein with a general knowledge of the relevant arts. Various modules may designate one or more components which may, in turn, comprise software and/or hardware designed to perform the intended function.

One or more aspects of the methods described herein are intended to be incorporated in an article of manufacture which may be shipped, sold, leased, or otherwise provided separately either alone or as part of a product suite or a service.

It will be appreciated that the above-disclosed and other features and functions, or alternatives thereof, may be desirably combined into other different systems or applications. Presently unforeseen or unanticipated alternatives, modifications, variations, or improvements may become apparent and/or subsequently made by those skilled in this art which are also intended to be encompassed by the following claims.

What is claimed is:

1. A method for securely sending a digital document to an intended recipient via facsimile transmission, the method comprising:
using a first fax device to obtain a digital document;
a first processor in association with the first fax device executing machine readable program instructions which configure the first processor to:
receive an access code from a sender of the digital document;
associate the access code with the digital document; and
communicate the digital document to a second fax device;
send the access code to a smartphone of an intended recipient over a cellular network; and
a second processor in association with the second fax device executing machine readable program instructions which configure the second processor to:
receive the digital document from the first fax device;
save the digital document to a storage device;
receive the access code from the intended recipient;
in response to the access code matching the access code associated with the digital document, retrieve the digital document associated with the access code from the storage device; and
communicate the digital document to a print engine which renders the digital document to a hardcopy print.

2. The method of claim 1, wherein the access code comprises any of: a sequence of numbers, a sequence of letters, an alphanumeric sequence, an image, a barcode, and data encoded on a RFID tag.

3. The method of claim 1, wherein the print engine is any of: internal to a remote printer located on a network, and internal to the second fax device.

4. The method of claim 1, wherein the first and second processors are the same processor.

5. The method of claim 1, wherein the machine readable program instructions comprise a service application installed on the first and second fax devices.

6. The method of claim 5, wherein the service application is installed on the sender's and intended recipient's smartphones.

7. The method of claim 1, wherein the access code is provided to the intended recipient by the first fax device.

8. The method of claim 1, wherein the access code is provided to the intended recipient using any of: a text message, an audio message, and an email.

9. The method of claim 1, wherein, in response to the digital document having been printed, deleting the digital document from the storage device.

10. The method of claim 1, wherein the access code is used as at least part of a filename of the digital document, wherein the filename is a name of the digital document saved to a storage device.

11. A system for securely sending a digital image of a hardcopy document to an intended recipient via facsimile transmission, the system comprising:
a first fax device to obtain a digital image of a hardcopy document;
a second fax device in networked communication with the first fax device;
a first processor in association with the first fax device executing machine readable program instructions to:
receive on a smart phone over a cellular network an access code from a sender;
associate the access code with the digital image; and
communicate the digital image to a second fax device; and
a second processor in association with the second fax device executing machine readable program instructions to:
receive the digital image from the first fax device;
save the digital image to a storage device;
receive the access code from the intended recipient;
in response to the access code matching the access code associated with the digital document, retrieve the digital document associated with the access code from the storage device; and
communicate the digital image to a print engine which renders the digital image to a hardcopy print.

12. The system of claim 11, wherein the access code comprises any of: a sequence of numbers, a sequence of letters, an alphanumeric sequence, an image, a barcode pattern, and data encoded on a RFID tag.

13. The system of claim 11, wherein the print engine is any of: internal to a remote printer located on a network, and internal to the second fax device.

14. The system of claim 11, wherein the first and second processors are the same processor.

15. The system of claim 11, wherein the machine readable program instructions comprise a service application installed on the first and second fax devices.

16. The system of claim 15, wherein the service application is installed on the sender's and intended recipient's smartphones.

17. The system of claim 11, wherein the access code is provided to the intended recipient by the first fax device.

18. The system of claim 11, wherein the access code is provided to the intended recipient using any of: a text message, an audio message, and an email.

19. The system of claim 11, wherein, in response to the digital image having been printed, deleting the digital image from the storage device.

20. The system of claim 11, wherein the access code is used as at least part of a filename of the digital image, wherein the filename is a name of the digital image saved to a storage device.
